(19) United States
(12) Patent Application Publication
(10) Pub. No.: US 2009/0232587 A1
(43) Pub. Date: Sep. 17, 2009

(54) HANDGRIP MOUNTING METHOD

(75) Inventor: Yung-Han WANG, Taichung Hsien (TW)

Correspondence Address: BROWDY AND NEIMARK, P.L.L.C.;624 NINTH STREET, NW, SUITE 300, WASHINGTON, DC, 20001-5303, US

(73) Assignee: HIGH CEDAR ENTERPRISE CO., LTD., Ching Shui Chen (TW)

(21) Appl. No.: 12/206,074

(22) Filed: Sep. 8, 2008

(30) Foreign Application Priority Data
Mar. 14, 2008 (TW) 97109246

(51) Int. Cl. B25G 3/12

(52) U.S. Cl. 403/17

(57) ABSTRACT

A handgrip mounting method for mounting a handgrip onto a handlebar includes the steps of a) applying a piece of releasable paper to one of a handlebar and a tubular handgrip, b) sleeving the tubular handgrip onto the handlebar to have the piece of releasable paper be sandwiched in between the handlebar and the tubular handgrip in such a manner that an end portion of the piece of releasable paper is exposed outside of the handlebar and the tubular handgrip, and c) pulling the end portion of the piece of releasable paper to remove the piece of releasable paper away from the handlebar and the tubular handgrip.

### BACKGROUND OF THE INVENTION

1. Field of the Invention

The present invention relates generally to handgrips for handlebars and more specifically to a handgrip mounting method for mounting a tubular handgrip on a handlebar.

2. Description of the Related Art

Conventionally, mounting a tubular handgrip on a handlebar is achieved by means of expanding the inner diameter of the tubular handgrip with a machine or by labor to an extent where the inner diameter of the tubular handgrip becomes greater than the outer diameter of the handlebar and then sleeving the tubular handgrip onto the handlebar.

The aforesaid handgrip mounting procedure is performed step by step, i.e., by means of widening the inner diameter of one segment of the tubular handgrip and sleeving the expanded first segment of the tubular handgrip onto the handlebar and then widening the inner diameter of a next segment of the tubular handgrip and forcing the expended second segment of the tubular handgrip onto the handlebar, and so forth. This handgrip mounting procedure is complicated, wasting much time and labor. Therefore, an improvement in this regard is necessary.

### SUMMARY OF THE INVENTION

The present invention has been accomplished in view of the above-noted circumstances. It is one objective of the present invention to provide a handgrip mounting method, which facilitates quick mounting of a tubular handgrip on a handlebar.

To achieve this objective of the present invention, the handgrip mounting method comprises the steps of:

a) applying a piece of releasable paper to one of a handlebar and a tubular handgrip to provide a lubrication effect in such a manner that an extending direction of the piece of releasable paper defines with a longitudinal axis of one of the handlebar and the tubular handgrip to which the piece of releasable paper is applied a contained angle smaller than 90 degrees;

b) sleeving the tubular handgrip onto the handlebar to have the piece of releasable paper be sandwiched in between the handlebar and the tubular handgrip and to have an end portion of the piece of releasable paper be exposed outside of the handlebar and the tubular handgrip; and

c) pulling the end portion of the piece of releasable paper to remove the piece of releasable paper away from the handlebar and the tubular handgrip.

According to this handgrip mounting method, the releasable paper works as a lubrication medium between the handlebar and the tubular handgrip so that the tubular handgrip can easily be sleeved onto the handlebar, saving much time and labor. After mounting of the tubular handgrip on the handlebar, the releasable paper is directly removed without any other complicated procedure.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWING

The present invention will become more fully understood from the detailed description given herein below and the accompanying drawings which are given by way of illustration only, and thus are not limitative of the present invention, and wherein:

FIG. 1 is a handgrip mounting flow chart according to a first embodiment of the present invention;

FIG. 2 is a schematic drawing showing two pieces of releasable paper applied to the periphery of a handlebar according to a first embodiment of the present invention;

FIG. 3 is a schematic drawing showing that the handlebar with the attached releasable paper is to be inserted into a tubular handgrip according to the first embodiment of the present invention;

FIG. 4 is a schematic drawing showing that the handlebar with the attached releasable paper is inserted into the tubular handgrip according to the first embodiment of the present invention;

FIG. 5 is a schematic drawing, showing the handlebar and the tubular handgrip bonded together after removal of the releasable paper according to the first embodiment of the present invention;

FIG. 6 is a schematic drawing showing that a releasable paper is spirally applied to the periphery of a handlebar according to a second embodiment of the present invention;

FIG. 7 is a schematic drawing showing that the handlebar with the attached releasable paper is to be inserted into a tubular handgrip according to the second embodiment of the present invention;

FIG. 8 is a schematic drawing, showing that the handlebar with the attached releasable paper is inserted into the tubular handgrip according to the second embodiment of the present invention;

FIG. 9 is a schematic drawing, showing the handlebar and the tubular handgrip bonded together after removal of the releasable paper according to the second embodiment of the present invention;

FIG. 10 is a schematic drawing showing that two pieces of releasable paper are applied to the inside wall of a tubular handgrip according to a third embodiment of the present invention;

FIG. 11 is a schematic drawing showing that a handlebar is to be inserted into the releasable paper bonded tubular handgrip according to the third embodiment of the present invention;

FIG. 12 is a schematic drawing showing that the tubular handgrip with the attached releasable paper is sleeved onto the handlebar according to the third embodiment of the present invention;

FIG. 13 is a schematic drawing showing the handlebar and the tubular handgrip bonded together after removal of the releasable paper according to the third embodiment of the present invention;

FIG. 14 is a schematic drawing showing that a releasable paper is spirally applied to the inside wall of a tubular handgrip according to a fourth embodiment of the present invention;

FIG. 15 is a schematic drawing showing that a handlebar is to be inserted into the releasable paper bonded tubular handgrip according to the fourth embodiment of the present invention;

FIG. 16 is a schematic drawing showing that the tubular handgrip with the attached releasable paper is sleeved onto the handlebar according to the fourth embodiment of the present invention; and

FIG. 17 is a schematic drawing showing the handlebar and the tubular handgrip bonded together after removal of the releasable paper according to the fourth embodiment of the present invention.

### DETAILED DESCRIPTION OF THE INVENTION

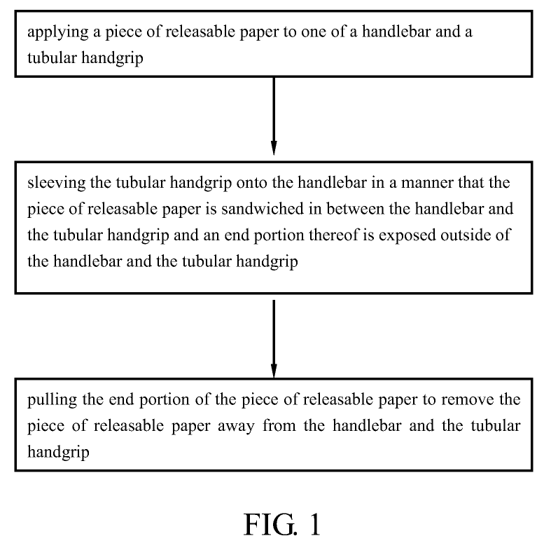

Referring to FIGS. 1-5, a handgrip mounting method in accordance with a first embodiment of the present invention includes the following steps:

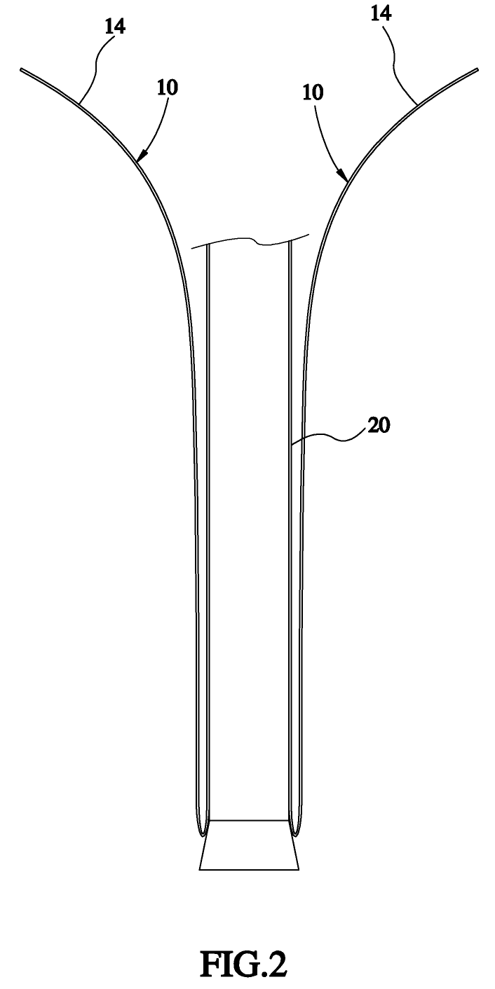

a) Apply two pieces of releasable paper 10 to two opposite sides of the periphery of a handlebar 20 or the inside wall of a tubular handgrip 30. According to this embodiment, the two narrow elongated pieces of releasable paper 10 are applied to the two opposite sides of the periphery of a handlebar 20 (see FIG. 2). The two pieces of releasable paper 10 provide a lubrication effect. By means of applying the two pieces of releasable paper 10 to the two opposite sides of the periphery of the handlebar 20, the two opposite sides of the periphery of the handlebar 20 have a same lubrication coefficient to facilitate mounting of the tubular handgrip 30. The handlebar 20 and the tubular handgrip 30 are arranged in a coaxial manner. The two pieces of releasable paper 10 extend along the length of the handlebar 20. The extending direction of each releasable paper 10 defines with the axis of the handlebar 20 a specific contained angle smaller than 90 degrees. According to this embodiment, this specific contained angle is zero degree. The tubular handgrip 30 can a one-piece member formed by means of a molding technique. Alternatively the tubular handgrip 30 can be made by means of a stitching technique or draw string technique. According to this embodiment, stitching a piece material into shape forms the tubular handgrip 30. This step of applying the two pieces of releasable paper 10 to the two opposite sides of the periphery of the handlebar 20 is performed subject to the following procedure:
a1) The specific contained angle defined between each piece of releasable paper 10 and the longitudinal axis of the handlebar 20 is zero degree; the two pieces of releasable paper 10 extend axially from one end of the handlebar 20; the two pieces of releasable paper 10 are bonded to the periphery of the handlebar 20 by means of a glue or double-sided adhesive; according to this embodiment, the two pieces of releasable paper 10 are bonded to the periphery of the handlebar 20 with a double-sided adhesive; and
a2) The two pieces of releasable paper 10 are bilaterally attached to one end of the periphery of the handlebar 20 and extend along the length to the other end of the periphery of the handlebar 20, and then the suspending part of each piece of releasable paper 10 that extends over the other end of the periphery of the handlebar 20 is turned backwards. Further, the double-sided adhesive does not cover the suspending part of each piece of releasable paper 10 that extends over the other end of the periphery of the handlebar 20.

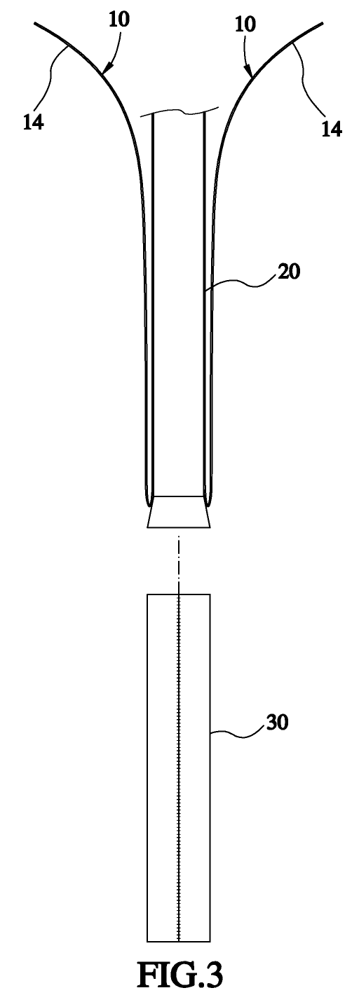

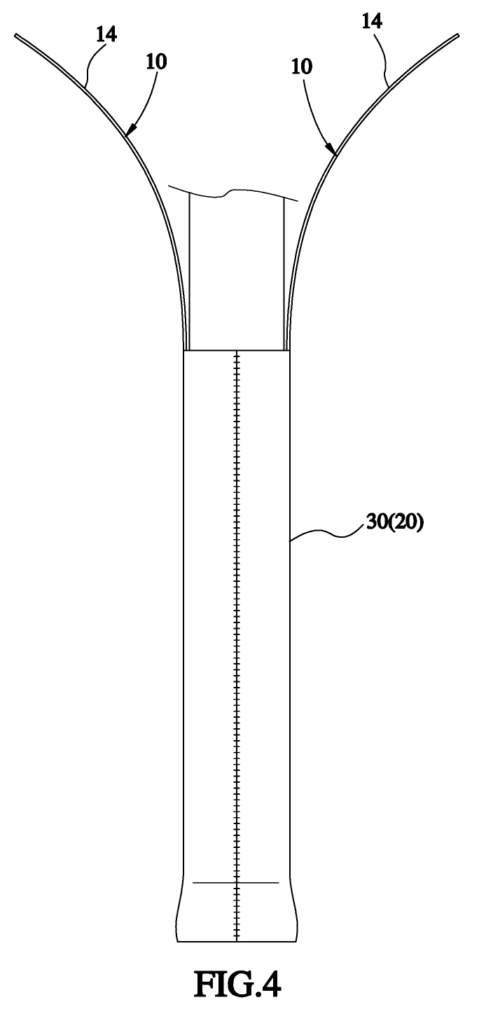

b) Sleeve the tubular handgrip 30 onto the handlebar 20 to have the two pieces of releasable paper. 10 be sandwiched in between the handlebar 20 and the tubular handgrip 30 with the end portion 14 of each piece of releasable paper 10 suspending outside of the handlebar 20 and the tubular handgrip 30 (see FIGS. 3 and 4).

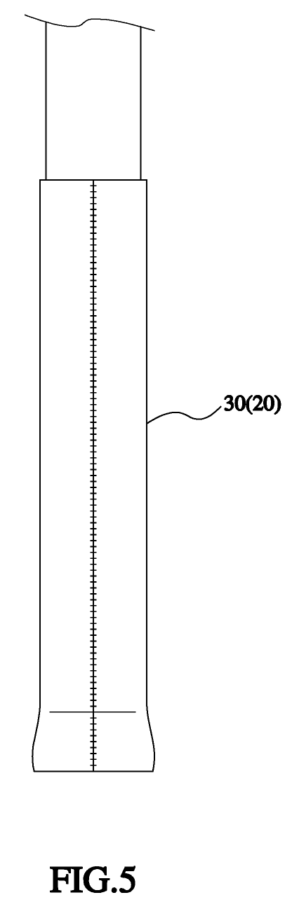

c) Pull the end portions 14 of the two pieces of releasable paper 10 to remove the two pieces of releasable paper 10 away from the handlebar 20 and the tubular handgrip 30. After removal of the two pieces of releasable paper 10 from the handlebar 20 and the tubular handgrip 30, the double-sided adhesive is bonded to the inside wall of the tubular handgrip 30, and therefore the tubular handgrip 30 is firmly bonded to the periphery of the handlebar 20 (see FIGS. 4 and 5).

According to the aforesaid first embodiment, the two pieces of releasable paper 10 work as a lubrication media between the handlebar 20 and the tubular handgrip 30 so that the tubular handgrip 30 can easily be sleeved onto the handlebar 20, solving the handgrip mounting problem of the prior art method. After mounting of the tubular handgrip 30 on the handlebar 20, the two pieces of releasable paper 10 can be directly removed without any other complicated procedure. Therefore, this handgrip mounting method is easy to perform. When compared with the prior art method, the invention simplifies the processing procedure and shortens the work time.

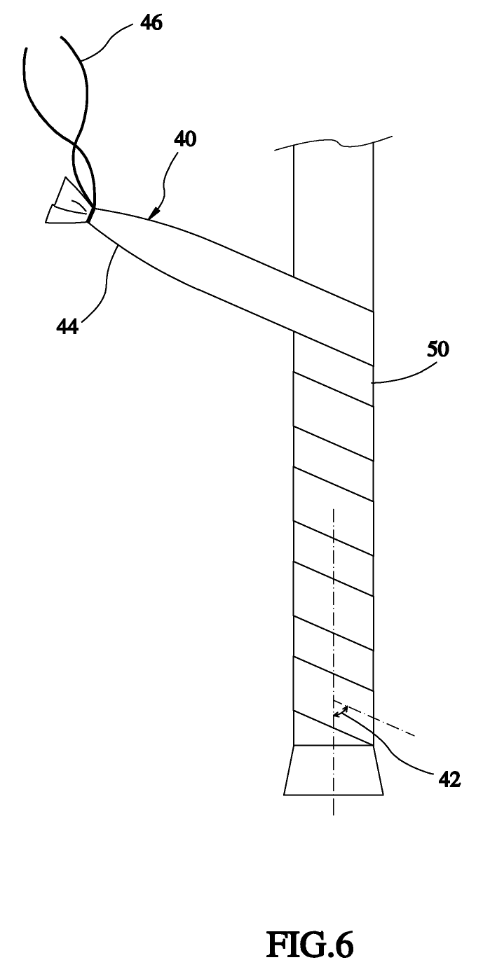

FIGS. 6-9 illustrate a handgrip mounting method in accordance with a second embodiment of the present invention. This second embodiment includes the following steps:

a) Apply a releasable paper 40 to the periphery of a handlebar 50 or the inside wall of a tubular handgrip 60. According to this embodiment, the releasable paper 40 is spirally applied to the periphery of a handlebar 50 (see FIG. 6). The releasable paper 40 provides a lubrication effect. The handlebar 50 and the tubular handgrip 60 are arranged in a coaxial manner. The releasable paper 40 is arranged on the periphery of the handlebar 50 and extended spirally around the length of the handlebar 50. The extending direction of the releasable paper 40 defines with the axis of the handlebar 50 a specific contained angle 42 smaller than 90 degrees. According to this embodiment, this specific contained angle is about 60 degrees. The tubular handgrip 60 can be formed by means of a one-piece molding technique. Alternatively the tubular handgrip 60 can be made by means of a stitching technique or draw string technique. According to this embodiment, stitching a piece material into shape forms the tubular handgrip 60. This step of applying the piece of releasable paper 40 to the periphery of the handlebar 50 is performed subject to the following procedure:
a1) The specific contained angle defined between the extending direction of the releasable paper 40 and the axis of the handlebar 50 is 60 degrees; the releasable paper 40 is spirally wound round the handlebar 50 from one end of the handlebar 50 toward the other end; the releasable paper 40 is bonded to the periphery of the handlebar 50 by means of a glue or double-sided adhesive; according to this embodiment, the releasable paper 40 is bonded to the periphery of the handlebar 50 with a glue; and

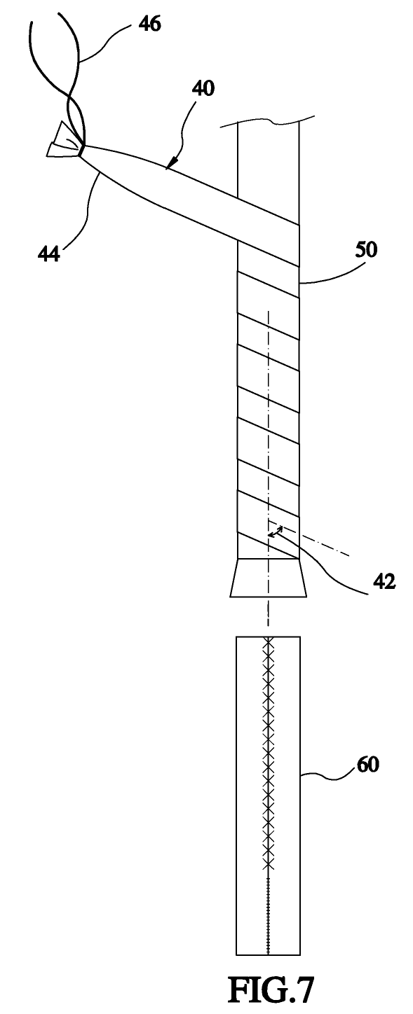

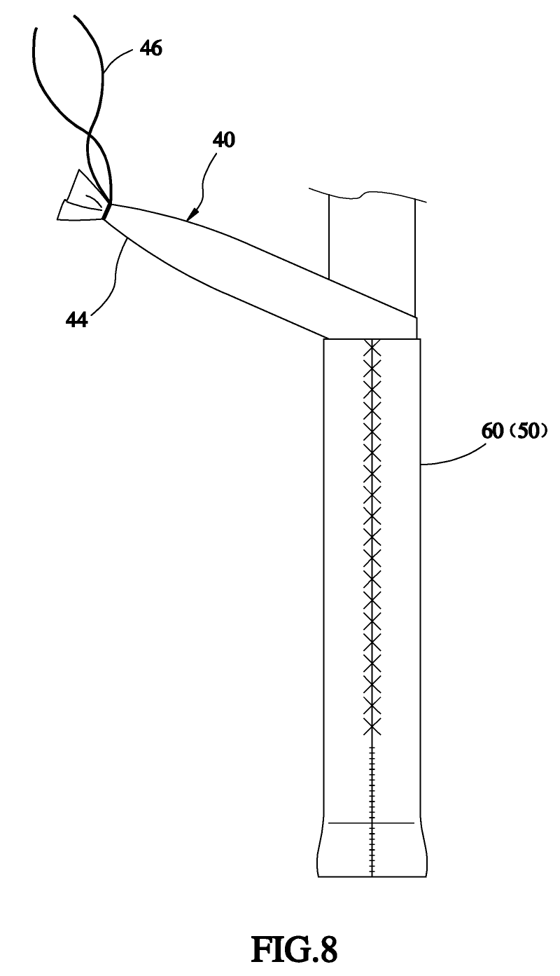

b) Sleeve the tubular handgrip 60 onto the handlebar 50 to have the releasable paper 40 be sandwiched in between the handlebar 50 and the tubular handgrip 60 with the end portion 44 of the releasable paper 40 suspending outside of the handlebar 50 and the tubular handgrip 60 (see FIGS. 7 and 8).

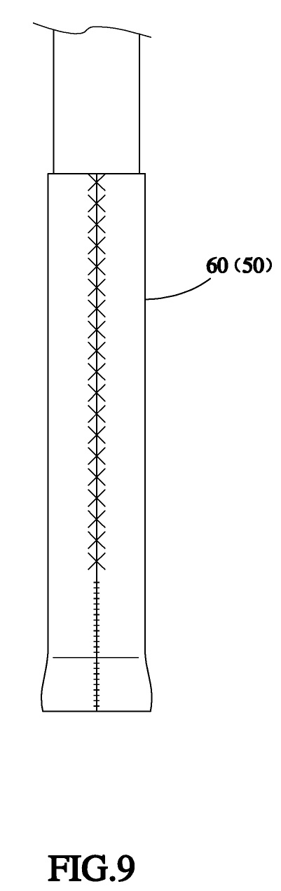

c) Pull the end portion 44 of the releasable paper 40 to remove the releasable paper 40 away from the handlebar 50 and the tubular handgrip 60. After removal of the releasable paper 40 from the handlebar 50 and the tubular handgrip 60, the inside wall of the tubular handgrip 60 is bonded to the periphery of the handlebar 50 (see FIGS. 8 and 9)

According to the aforesaid second embodiment, the releasable paper 40 works as a lubrication medium between the handlebar 50 and the tubular handgrip 60 so that the tubular handgrip 30 can easily be sleeved onto the handlebar 50. This second embodiment achieves the same effects as the aforesaid first embodiment but using only one piece of releasable paper.

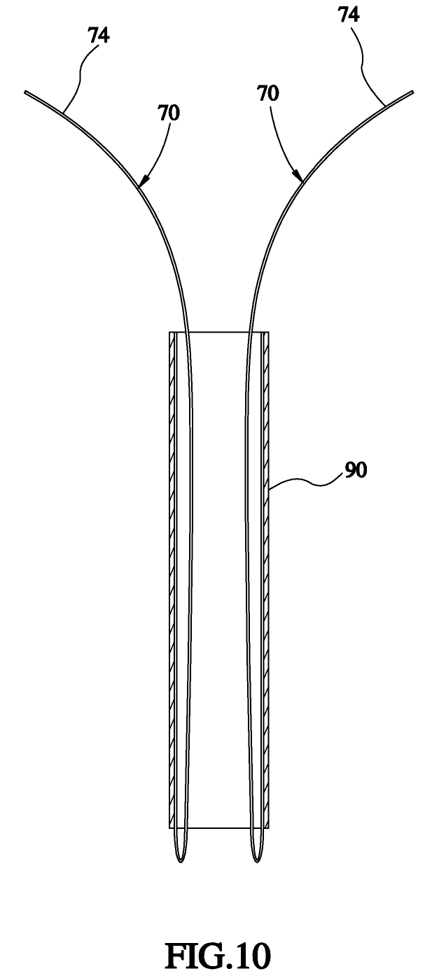

FIGS. 10-13 illustrate a handgrip mounting method in accordance with a third embodiment of the present invention. This third embodiment includes the following steps:

a) Apply two pieces of releasable paper 70 to two opposite sides of the periphery of a handlebar 80 or the inside wall of a tubular handgrip 90. According to this embodiment, the two narrow elongated pieces of releasable paper 70 are bilaterally applied to the inside wall of the tubular handgrip 90 (see FIG. 10). Same as the aforesaid first and second embodiments, the two pieces of releasable paper 70 provide a lubrication effect. The handlebar 80 and the tubular handgrip 90 are arranged in a coaxial manner. The two pieces of releasable paper 70 extend along the length of the tubular handgrip 90. The extending direction of each releasable paper 70 defines with the axis of the tubular handgrip 90 a specific contained angle of zero degree. The tubular handgrip 90 can be a one-piece member formed by means of a molding technique. Alternatively the tubular handgrip 90 can be made by means of a stitching technique or draw string technique. According to this embodiment, the tubular handgrip 90 is made by means of a draw string technique. This step of applying the two pieces of releasable paper 70 to the inside wall of the tubular handgrip 90 is performed subject to the following procedure:
a1) The specific contained angle defined between each piece of releasable paper 70 and the tubular handgrip 90 is zero degree; the two pieces of releasable paper 70 extend axially from one end of the handlebar 80 toward the other end thereof; the two pieces of releasable paper 70 are bonded to the periphery of the handlebar 80 by means of a glue or double-sided adhesive; according to this embodiment, the two pieces of releasable paper 70 are bonded to the periphery of the handlebar 80 with a double-sided adhesive; and
a2) The two pieces of releasable paper 70 are bilaterally attached to one end of the inside wall of the tubular handgrip 90 and extend along the length to the other end of the inside wall of the tubular handgrip 90, and then the suspending part of each piece of releasable paper 70 that extends over the other end of the tubular handgrip 90 is turned backwards. Further, the double-sided adhesive does not cover the suspending part of each piece of releasable paper 70 that suspends outside the tubular handgrip 90.

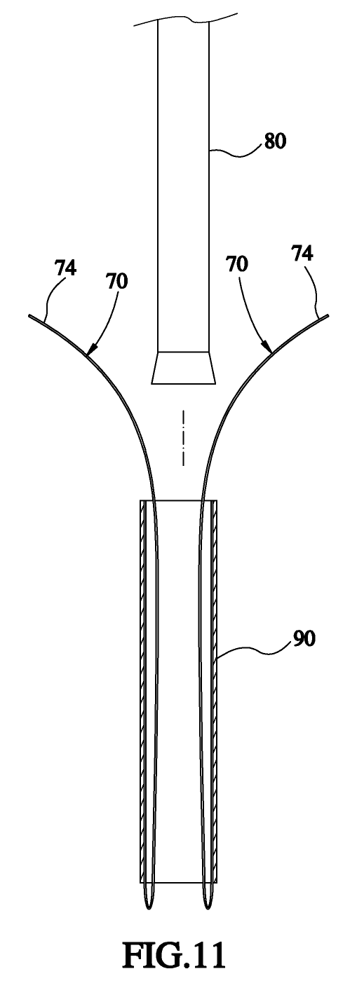

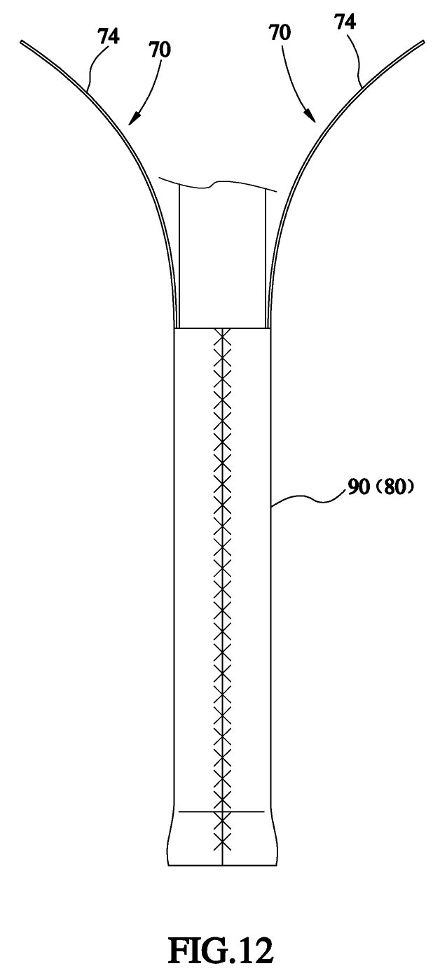

b) Sleeve the tubular handgrip 90 onto the handlebar 80 to have the two pieces of releasable paper. 70 be sandwiched in between the handlebar 80 and the tubular handgrip 90 with the end portion 74 of each piece of releasable paper 70 suspending outside of the handlebar 80 and the tubular handgrip 90 (see FIGS. 11 and 12).

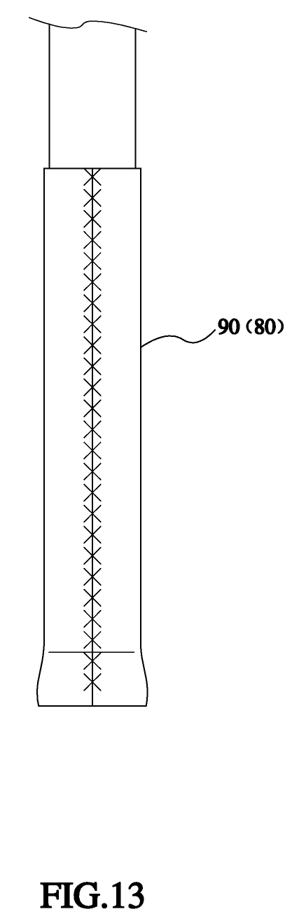

c) Pull the end portions 74 of the two pieces of releasable paper 70 to remove the two pieces of releasable paper 70 away from the handlebar 80 and the tubular handgrip 90. After removal of the two pieces of releasable paper 70 from the handlebar 80 and the tubular handgrip 90, the double-sided adhesive is bonded to the periphery of the handlebar 80, and therefore the handlebar 80 and the tubular handgrip 90 are fixedly fastened together (see FIGS. 12 and 13).

According to the aforesaid third embodiment, the two pieces of releasable paper 70 work as a lubrication media between the handlebar 80 and the tubular handgrip 90 so that the tubular handgrip 90 can easily be sleeved onto the handlebar 80, solving the handgrip mounting problem of the prior art method. After mounting of the tubular handgrip 90 on the handlebar 80, the two pieces of releasable paper 70 can be directly removed without any other complicated procedure. The two pieces of releasable paper 70 can be applied to the tubular handgrip 90, achieving the same effect. Therefore, this handgrip mounting method is easy to perform. When compared with the prior art method, the invention simplifies the processing procedure and shortens the work time, i.e., this third embodiment achieves the same effects as the aforesaid first and second embodiments.

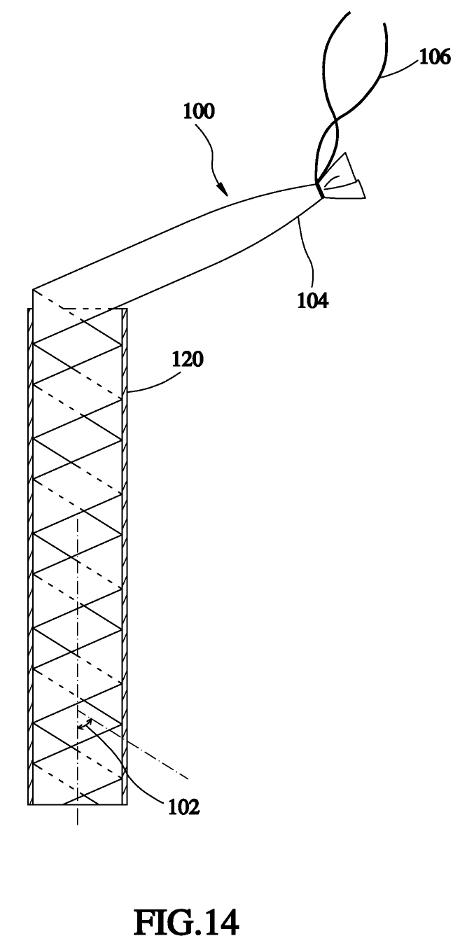

FIGS. 14-17 illustrate a handgrip mounting method in accordance with a fourth embodiment of the present invention. This fourth embodiment includes the following steps:

a) Apply a releasable paper 100 to the inside wall of the tubular handgrip 120 (see FIG. 14). The releasable paper 100 provides a lubrication effect. The handlebar 110 and the tubular handgrip 120 are arranged in a coaxial manner. The releasable paper 100 is spirally arranged on the inside wall of the tubular handgrip 120 and extended from one end of the tubular handgrip 120 toward the other end thereof. The extending direction of the releasable paper 100 defines with the axis of the tubular handgrip 120 a specific contained angle 102 of about 60 degrees. The tubular handgrip 120 is a one-piece member formed by means of a molding technique in this embodiment. This step of applying the piece of releasable paper 100 to the inside wall of the tubular handgrip 120 is performed subject to the following procedure:
a1) The specific contained angle 102 defined between the extending direction of the releasable paper 100 and the axis of the tubular handgrip 120 is set in 60 degrees; the releasable paper 100 is spirally extended along the inside wall of the tubular handgrip 120 from one end of the inside wall of the tubular handgrip 120 toward the other end; the releasable paper 100 is bonded to the inside wall of the tubular handgrip 120 by means of a glue in this embodiment; and

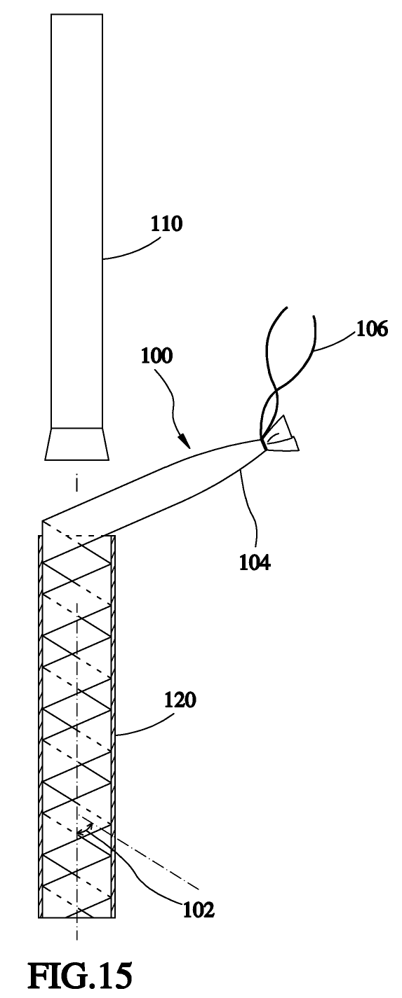

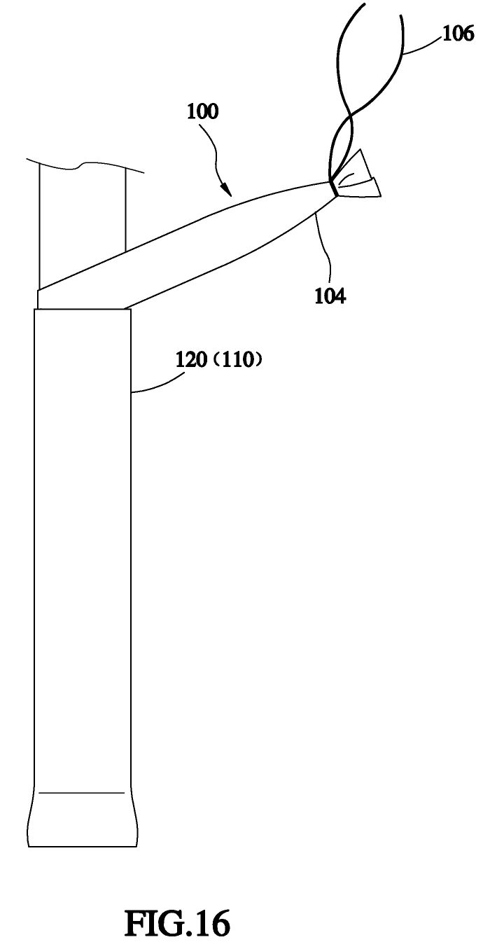

b) Sleeve the tubular handgrip 120 onto the handlebar 110 to have the releasable paper. 100 be sandwiched in between the handlebar 110 and the tubular handgrip 120 with the end portion 104 of the releasable paper 100 suspending outside of the handlebar 110 and the tubular handgrip 120 (see FIGS. 15 and 16). Further, the end portion 104 of the releasable paper 100 is provided with a cord member 106 for pulling by an external force.

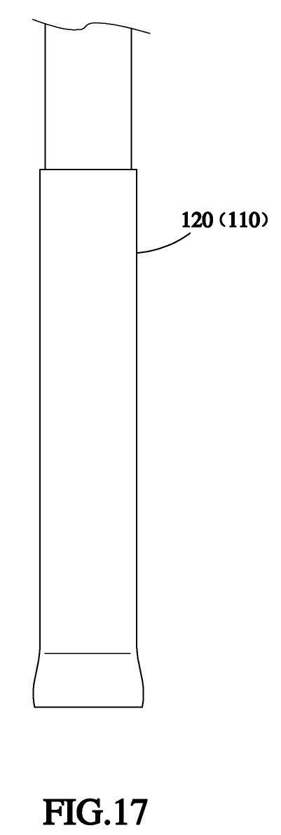

c) Pull the cord member 106 at the end portion 104 of the releasable paper 100 to remove the releasable paper 100 away from the handlebar 110 and the tubular handgrip 120. After removal of the releasable paper 100 from the handlebar 110 and the tubular handgrip 120, the inside wall of the tubular handgrip 120 is bonded to the periphery of the handlebar 110 (see FIGS. 16 and 17)

According to the aforesaid fourth embodiment, the releasable paper 100 works as a lubrication medium between the handlebar 110 and the tubular handgrip 120 so that the tubular handgrip 120 can easily be sleeved onto the handlebar 110. This fourth embodiment does not limit the mounting of the releasable paper 100 to the tubular handgrip 120. The releasable paper 100 can be applied to the periphery of the handlebar 110, achieving the same effect of facilitating the installation of the installation. Therefore, this fourth embodiment achieves the same effects as the aforesaid first, second and third embodiments.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A handgrip mounting method for mounting a tubular handgrip onto a handlebar, comprising the steps of:
a) applying a piece of releasable paper to one of a handlebar and a tubular handgrip to provide a lubrication effect in such a manner that an extending direction of the piece of releasable paper defines with a longitudinal axis of one of the handlebar and the tubular handgrip to which the piece of releasable paper is applied a contained angle smaller than 90 degrees;
b) sleeving the tubular handgrip onto the handlebar to have the piece of releasable paper be sandwiched in between the handlebar and the tubular handgrip and to have an end portion of the piece of releasable paper be exposed outside of the handlebar and the tubular handgrip; and
c) pulling the end portion of the piece of releasable paper to remove the piece of releasable paper away from the handlebar and the tubular handgrip.

2. The handgrip mounting method as claimed in claim 1, wherein the step a) of applying the piece of releasable paper to one of the handlebar and the tubular handgrip includes the steps of:
a1) applying the piece of releasable paper on the handlebar in such a manner that the specific contained angle is kept in zero degree and the piece of releasable paper extends axially from one end of the handlebar over an opposite end of the handlebar such that a part of the piece of releasable paper suspends outside the opposite end of the handlebar; and
a2) folding and extending the part of the piece of releasable paper from the opposite end of the handlebar over the end of the handlebar.

3. The handgrip mounting method as claimed in claim 1, wherein the step a) of applying the piece of releasable paper to one of the handlebar and the tubular handgrip includes the step of:
a1) applying the piece of releasable paper on the handlebar in such a manner that the specific contained angle is set greater than zero degree and the piece of releasable paper is spirally wound around the handlebar.

4. The handgrip mounting method as claimed in claim 1, wherein the step a) of applying the piece of releasable paper to one of the handlebar and the tubular handgrip includes the steps of:
a1) applying the piece of releasable paper on an inside wall of the tubular handgrip in such a manner that the specific contained angle is kept in zero degree and the piece of releasable paper extends axially from one end of the tubular handgrip over an opposite end of the tubular handgrip such that a part of the piece of releasable paper suspends outside the opposite end of the tubular handgrip; and
a2) folding and extending the part of the piece of releasable paper from the opposite end of the tubular handgrip over the end of the tubular handgrip.

5. The handgrip mounting method as claimed in claim 1, wherein the step a) of applying the piece of releasable paper to one of the handlebar and the tubular handgrip includes the step of:
a1) applying the piece of releasable paper on an inside wall of the tubular handgrip in such a manner that the specific contained angle is set greater than zero degree and the piece of releasable paper is spirally wound around the inside wall of the tubular handgrip.

6. The handgrip mounting method as claimed in claim 1, wherein the tubular handgrip is a one-piece member formed by means of a molding technique.

7. The handgrip mounting method as claimed in claim 1, wherein the tubular handgrip is made by means of a stitching technique or a draw string technique.

8. The handgrip mounting method as claimed in claim 1, wherein the piece of releasable paper is applied to one of the handlebar and the tubular handgrip with a glue or a double-sided adhesive in step a).

9. The handgrip mounting method as claimed in claim 1, wherein the end portion of the piece of releasable paper is provided with a cord member for pulling by an external force to remove the piece of releasable paper in step b).
